(19) United States
(12) Patent Application Publication
(10) Pub. No.: US 2025/0053722 A1
(43) Pub. Date: Feb. 13, 2025

(54) Automated Printed Circuit Board Component Clustering

(71) Applicant: Cadence Design Systems, Inc., San Jose, CA (US)

(72) Inventors: Dominik Martinez, Cambridge, MA (US); Shang Li, Wakefield, MA (US); John Robert Murphy, New York, NY (US); Mirko Spasojevic, Palo Alto, CA (US)

(21) Appl. No.: 18/448,348

(22) Filed: Aug. 11, 2023

(51) Int. Cl. G06F 30/398; G06F 30/31

(52) U.S. Cl. CPC G06F 30/398; G06F 30/31; G06F 2115/12

(57) ABSTRACT

The present disclosure relates to a system and method for automated printed circuit board (PCB) component placement. Embodiments may include receiving a PCB outline, one or more constraints, and a netlist having PCB component details and applying a clustering algorithm to generate one or more clustered groups. Embodiments may further include applying a grid based local cluster placement algorithm to the one or more clustered groups. Embodiments may also include applying a global cluster placement algorithm and generating a fully optimized placed design.

### FIELD OF THE INVENTION

The present disclosure relates to electronic design systems, and more specifically, to a process for automating printed circuit board component clustering in an electronic design.

### DISCUSSION OF THE RELATED ART

Printed circuit board (PCB) component placement is a highly nonlinear multi-objective optimization problem that must consider physical restrictions, pin connections as specified in the netlist, and other electrical properties. There are typically multiple solutions for a given PCB placement problem, and each solution may come with different trade-offs. PCB component placement is a complex problem that can take PCB designers a significant amount of time to manually complete.

### SUMMARY

In one or more embodiments of the present disclosure a method for automated printed circuit board (PCB) component placement is provided. The method may include receiving a PCB outline and a netlist having PCB component details and applying a clustering algorithm to generate one or more clustered groups. The method may further include applying a grid based local cluster placement algorithm to the one or more clustered groups. The method may also include applying a global cluster placement algorithm and generating a fully optimized placed design.

One or more of the following features may be included. The method may include providing a first current placement from a clustering algorithm as feedback to the clustering algorithm. The method may further include providing a second current placement from a global cluster placement algorithm as feedback to the global cluster placement algorithm. The method may also include providing a third current placement from a grid based local cluster placement algorithm as feedback to the grid based local cluster placement algorithm. The global cluster placement algorithm may include conjugate gradient descent optimization. The method may further include providing feedback to optimize placement for wire length and routability. The clustering algorithm may include spectral clustering approaches. The grid based local cluster placement algorithm may include identifying a component having a largest number of pins. The method may also include generating a visualization at a graphical user interface including global placement results. The fully optimized placed design may be placed and routed on a same layer.

In another embodiment of the present disclosure a computer-readable medium having stored thereon instructions that when executed by a processor result in one or more operations is provided. Operations may include receiving a PCB outline and a netlist having PCB component details and applying a clustering algorithm to generate one or more clustered groups. Operations may further include applying a grid based local cluster placement algorithm to the one or more clustered groups. Operations may also include applying a global cluster placement algorithm and generating a fully optimized placed design.

One or more of the following features may be included. Operations may include providing a first current placement from a clustering algorithm as feedback to the clustering algorithm. Operations may further include providing a second current placement from a global cluster placement algorithm as feedback to the global cluster placement algorithm. Operations may also include providing a third current placement from a grid based local cluster placement algorithm as feedback to the grid based local cluster placement algorithm. The global cluster placement algorithm may include conjugate gradient descent optimization. Operations may further include providing feedback to optimize placement for wire length and routability. The clustering algorithm may include spectral clustering approaches. The grid based local cluster placement algorithm may include identifying a component having a largest number of pins. Operations may also include generating a visualization at a graphical user interface including global placement results. The fully optimized placed design may be placed and routed on a same layer.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 is a diagram depicting an embodiment of a system in accordance with the present disclosure;

FIG. 2 is a flowchart depicting operations consistent with the PCB component clustering process in accordance with an embodiment of the present disclosure;

FIG. 3 is another flowchart depicting operations consistent with the PCB component clustering process in accordance with an embodiment of the present disclosure;

FIG. 4 is a graphical user interface consistent with the PCB component clustering process in accordance with an embodiment of the present disclosure;

FIG. 5 is a graphical user interface consistent with the PCB component clustering process in accordance with an embodiment of the present disclosure;

FIG. 6 is a diagram showing an example of location generation during local placement in accordance with an embodiment of the present disclosure;

FIGS. 7-10 show example diagrams of grid-based local placement in accordance with an embodiment of the present disclosure;

FIG. 11 show an example of gradient descent global placement in accordance with an embodiment of the present disclosure;

FIGS. 12-15 show example diagrams of force computations in accordance with an embodiment of the present disclosure; and

FIGS. 16-17 show an example of gradient descent global placement in accordance with an embodiment of the present disclosure.

### DETAILED DESCRIPTION

Reference will now be made in detail to the embodiments of the present disclosure, examples of which are illustrated in the accompanying drawings. The present disclosure may, however, be embodied in many different forms and should not be construed as being limited to the embodiments set forth herein. Rather, these embodiments are provided so that this disclosure will be thorough and complete, and will fully convey the concept of the disclosure to those skilled in the art.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

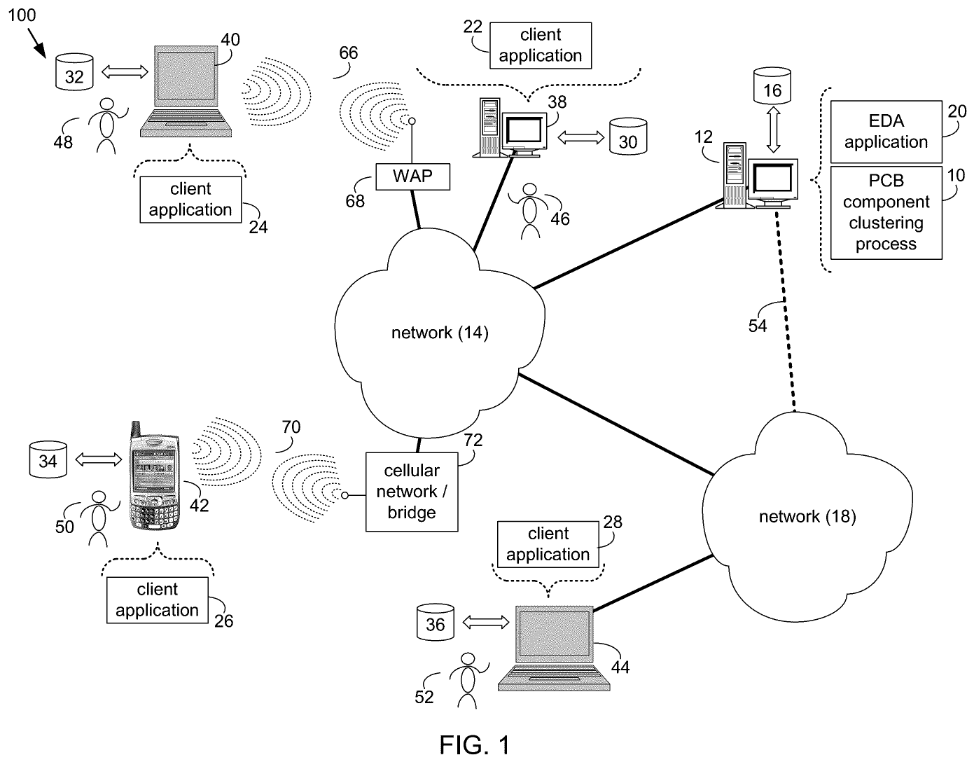

Referring to FIG. 1, there is shown PCB component clustering process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer, Amazon EC2 (or similar cloud hosting). Process 10 may also leverage any combination of AWS webservices and scalable compute. Server computer 12 may be a web server (or a series of servers) running a network operating system, examples of which may include but are not limited to: Microsoft® Windows® Server; Novell® NetWare®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.) Additionally/alternatively, PCB component clustering process 10 may reside on and be executed, in whole or in part, by a client electronic device, such as a personal computer, notebook computer, personal digital assistant, or the like.

The instruction sets and subroutines of the PCB component clustering process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM). Storage device 16 may include various types of files and file types.

Server computer 12 may execute a web server application, examples of which may include but are not limited to: Microsoft IIS, Novell Webserver™, or Apache® Webserver, that allows for HTTP (e.g., HyperText Transfer Protocol) access to server computer 12 via network 14 (Webserver is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Server computer 12 may execute an electronic design automation (EDA) application (e.g., EDA application 20), examples of which may include, but are not limited to those available from the assignee of the present application. EDA application 20 may interact with one or more EDA client applications (e.g., EDA client applications 22, 24, 26, 28) for electronic design optimization.

PCB component clustering process 10 may be a standalone application, or may be an applet/application/script that may interact with and/or be executed within EDA application 20. In addition/as an alternative to being a server-side process, the PCB component clustering process 10 may be a client-side process (not shown) that may reside on a client electronic device (described below) and may interact with an EDA client application (e.g., one or more of EDA client applications 22, 24, 26, 28). Further, PCB component clustering process 10 may be a hybrid server-side/client-side process that may interact with EDA application 20 and an EDA client application (e.g., one or more of client applications 22, 24, 26, 28). As such, the processes may reside, in whole, or in part, on server computer 12 and/or one or more client electronic devices.

The instruction sets and subroutines of EDA application 20, which may be stored on storage device 16 coupled to server computer 12 may be executed by one or more processors (not shown) and one or more memory modules (not shown) incorporated into server computer 12.

The instruction sets and subroutines of EDA client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44 (respectively). Storage devices 30, 32, 34, 36 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, mobile computing device 42 (such as a smart phone, netbook, or the like), notebook computer 44, for example. Using client applications 22, 24, 26, 28, users 46, 48, 50, 52 may access EDA application 20 and may allow users to e.g., utilize PCB component clustering process 10.

Users 46, 48, 50, 52 may access EDA application 20 directly through the device on which the client application (e.g., client applications 22, 24, 26, 28) is executed, namely client electronic devices 38, 40, 42, 44, for example. Users 46, 48, 50, 52 may access EDA application 20 directly through network 14 or through secondary network 18. Further, server computer 12 (e.g., the computer that executes EDA application 20) may be connected to network 14 through secondary network 18, as illustrated with phantom link line 54. Some or all of the operations discussed herein with regard to PCB component clustering process 10 may be performed, in whole or in part, in the cloud as a cloud-based process including, for example, networks 14, 18 and any others.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 66 established between laptop computer 40 and wireless access point (e.g., WAP) 68, which is shown directly coupled to network 14. WAP 68 may be, for example, an IEEE 802.11a, 802.11b, 802.11g, Wi-Fi, and/or Bluetooth device that is capable of establishing wireless communication channel 66 between laptop computer 40 and WAP 68. Mobile computing device 42 is shown wirelessly coupled to network 14 via wireless communication channel 70 established between mobile computing device 42 and cellular network/bridge 72, which is shown directly coupled to network 14.

As is known in the art, all of the IEEE 802.11x specifications may use Ethernet protocol and carrier sense multiple access with collision avoidance (e.g., CSMA/CA) for path sharing. The various 802.11x specifications may use phase-shift keying (e.g., PSK) modulation or complementary code keying (e.g., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows, Microsoft Windows CE®, Red Hat Linux, or other suitable operating system. (Windows CE is a registered trademark of Microsoft Corporation in the United States, other countries, or both.).

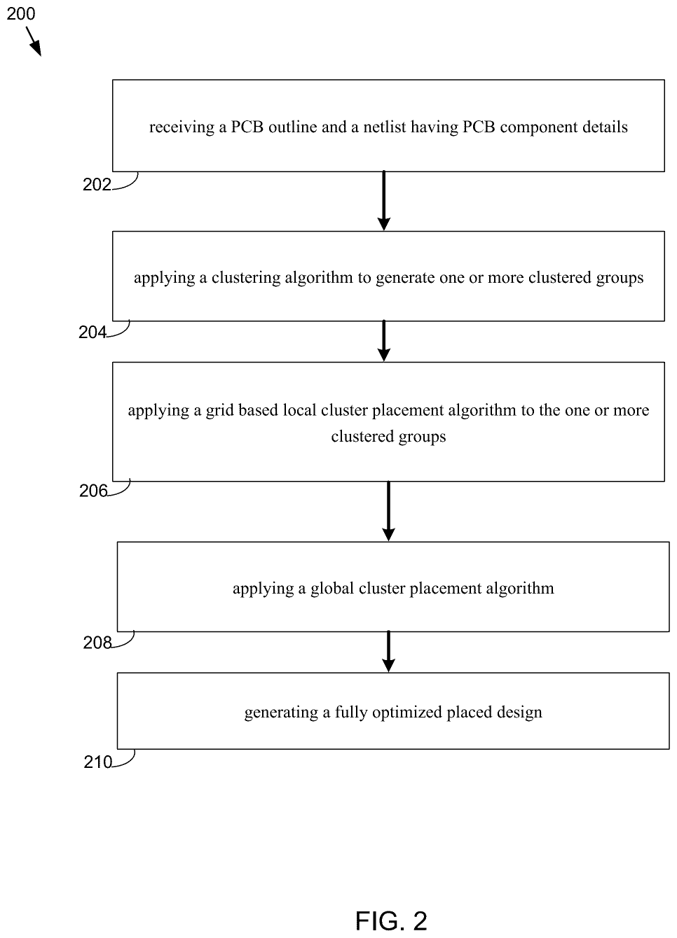

Referring now to FIG. 2, an example flowchart depicting operations consistent with an embodiment of PCB component clustering process 10 is provided. The method may include receiving (202) a PCB outline and a netlist having PCB component details and applying (204) a clustering algorithm to generate one or more clustered groups. The method may further include applying (206) a grid based local cluster placement algorithm to the one or more clustered groups. The method may also include applying (208) a global cluster placement algorithm and generating (210) a fully optimized placed design. Numerous other operations are also within the scope of the present disclosure.

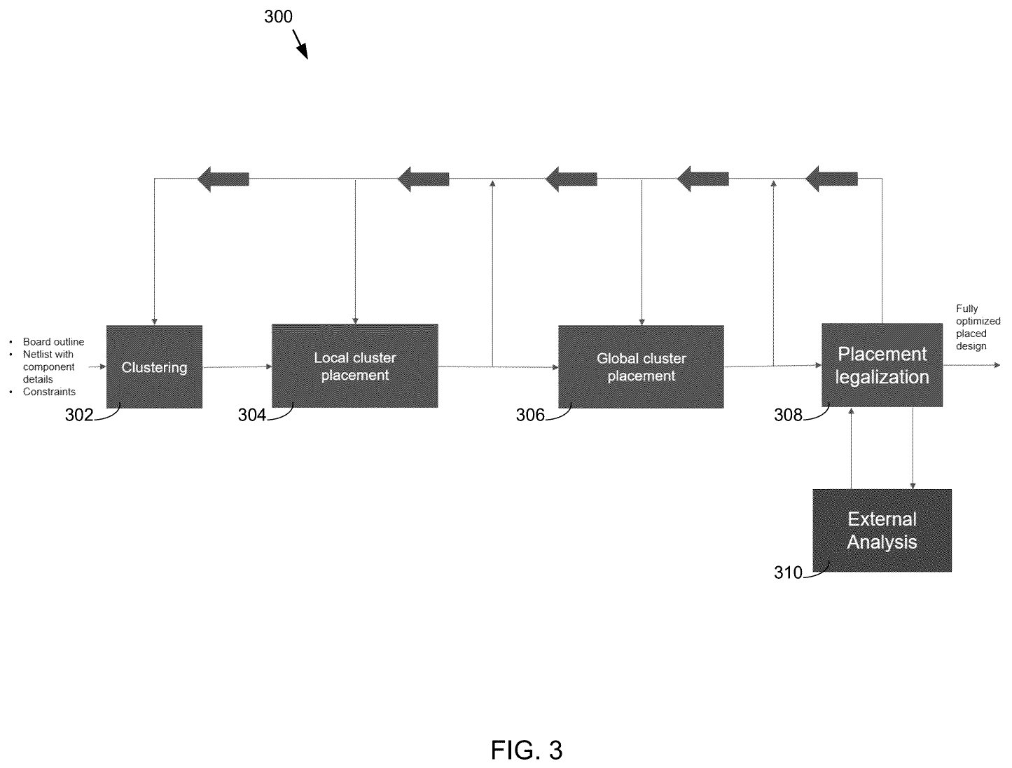

Referring now to FIG. 3, another flowchart 300 showing operations consistent with embodiments of PCB component clustering process 10 is provided. Embodiments of PCB component clustering process 10 provide an automated PCB component placement methodology that requires minimum user interaction. In some embodiments, process 10 may employ a netlist and constraints-based clustering algorithm and may utilize multiple optimization techniques. Some of these may include, but are not limited to, grid-based local cluster placement and gradient descent global cluster placement. As shown in FIG. 3, process 10 may receive a PCB outline, one or more netlists with component details and one or more constraints at clustering module 302. In some embodiments, the constraints may be optional. The phrase “board outline”, as used herein, may refer to a geometric representation of the physical PCB board, such as a rectangle, etc. The term “netlist”, as used herein, may refer to a mapping of pins to net names and may include a full mapping of every pin on the board. For example, Component 1-Pin 1 may be on net “GND”, which Component 1-Pin 2 may be on net “PWR”. Common constraints are minimum gaps between components. This is generally just a mapping between two components and a scalar value with a unit (e.g., Comp. C1-Comp. C2: 5 mm, etc.). Clustering module 302 provides an output to local cluster placement module 304. Global cluster placement 306 and placement legalization 308 may then be performed prior to the generation of a fully optimized placed PCB design and/or any external analysis 310 is performed.

In some embodiments, and as shown in FIG. 3, PCB component clustering process 10 may utilize a feedback mechanism to optimize the placement for wire length, routability, and other suitable metrics. This feedback may occur after each of the operations shown in FIG. 3 as the current placement may be fed back to a prior operation. Some or all of the operations associated with PCB component clustering process 10 may be deployed, in whole or in part, to a cloud computing devices (such as those shown in FIG. 1) to leverage the resource provisioning and flexibility of a cloud environment.

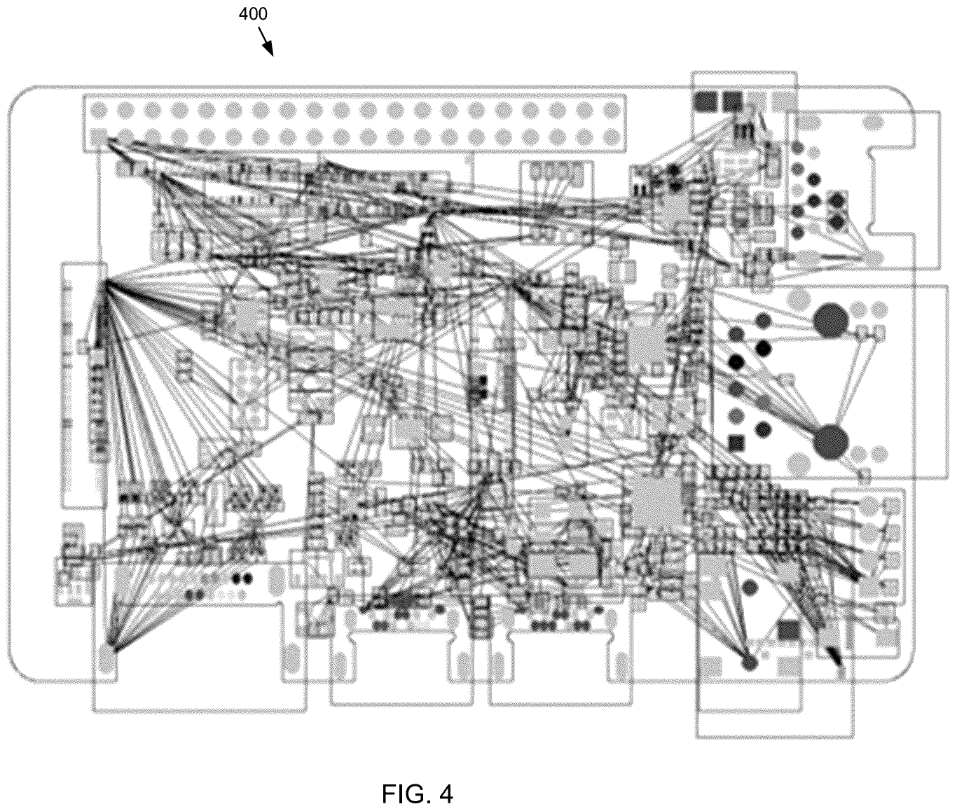

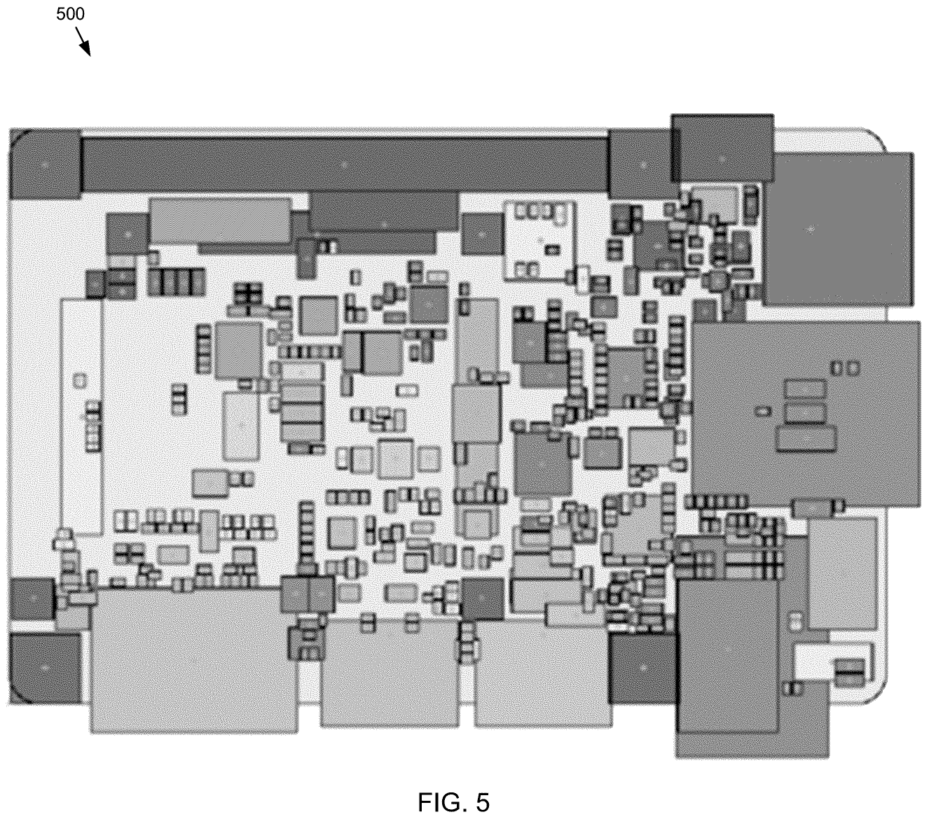

Referring now to FIGS. 4-5, diagram 400 shows an example where connections are overlaid on a human placed design. In contrast, diagram 500 shows an example of clustering using clustering module 302 associated with an embodiment of PCB component clustering process 10. Similarly, in FIG. 5, the clusters may be overlaid on the human placed design. In some embodiments the input may include the netlist of the electronic design. The netlist may be used to construct a graph of the connections. One or more graph clustering algorithms may be applied to the netlist graph to generate groupings. Any suitable algorithm may be employed, including, but not limited to, spectral clustering. The output may include the collection of component groups on the PCB.

In some embodiments, and referring again to FIG. 5, process 10 may be configured to generate one or more visualizations that may provide the designer with a better view of the various clusters. For example, each of the clusters depicted in FIG. 5 may be color-coded and/or visually differentiated from each other. Process 10 may apply colors based upon any suitable metric and/or based upon user defined parameters.

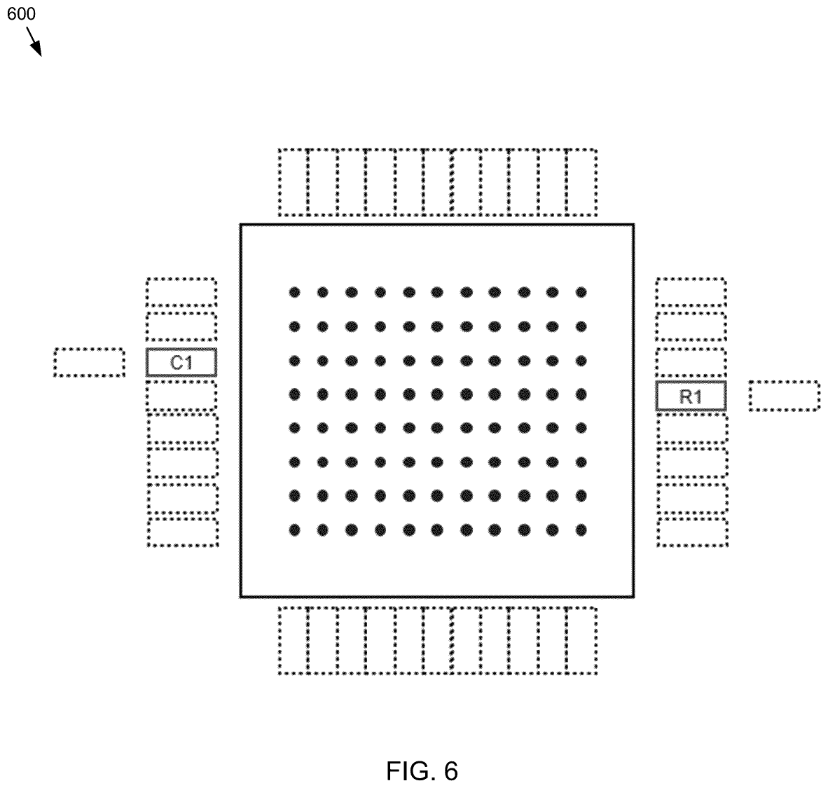

Referring now to FIG. 6, a diagram 600 showing an example of grid-based local placement consistent with embodiments of PCB component clustering process 10 is provided. PCB component clustering process 10 may be configured to apply grid-based local placement to each cluster individually. Accordingly, for each cluster, process 10 may identify an initial main component. This may be selected by identifying the component with the largest number of pins. Process 10 may place each component around the previously placed components. Accordingly, the placements may be aligned to the previously placed pins and the new location may be selected to minimize wirelength. The output may include the placement of components in a cluster. In some embodiments, multiple placements of the same cluster may be generated with different constraints.

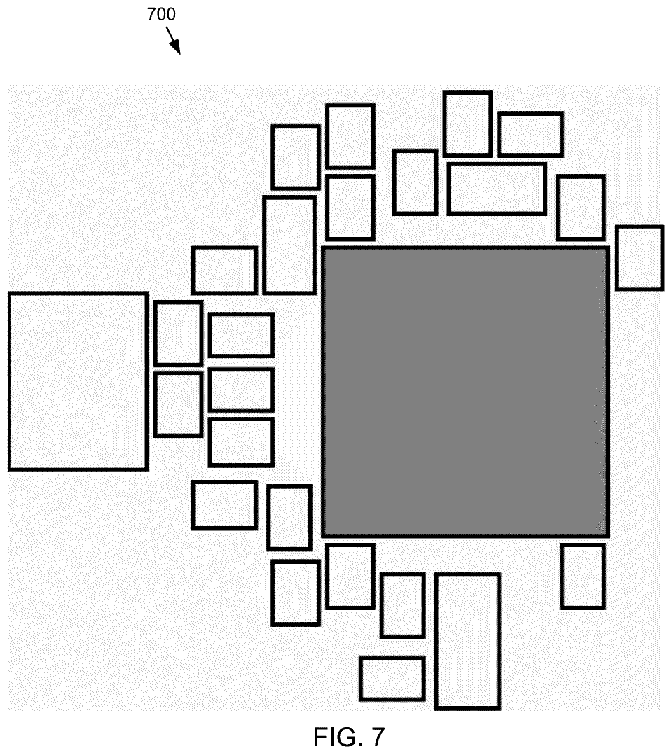

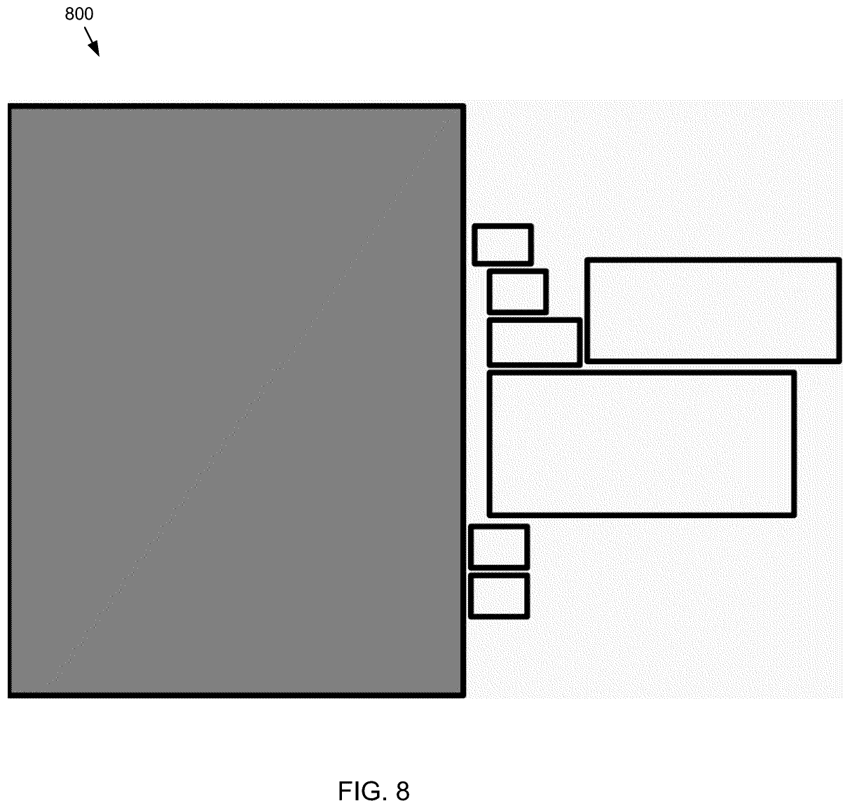

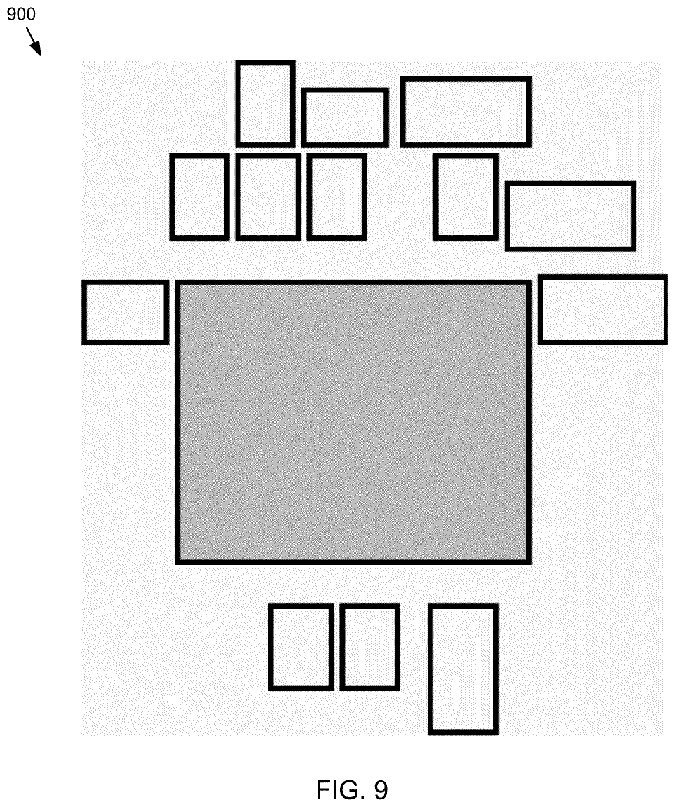

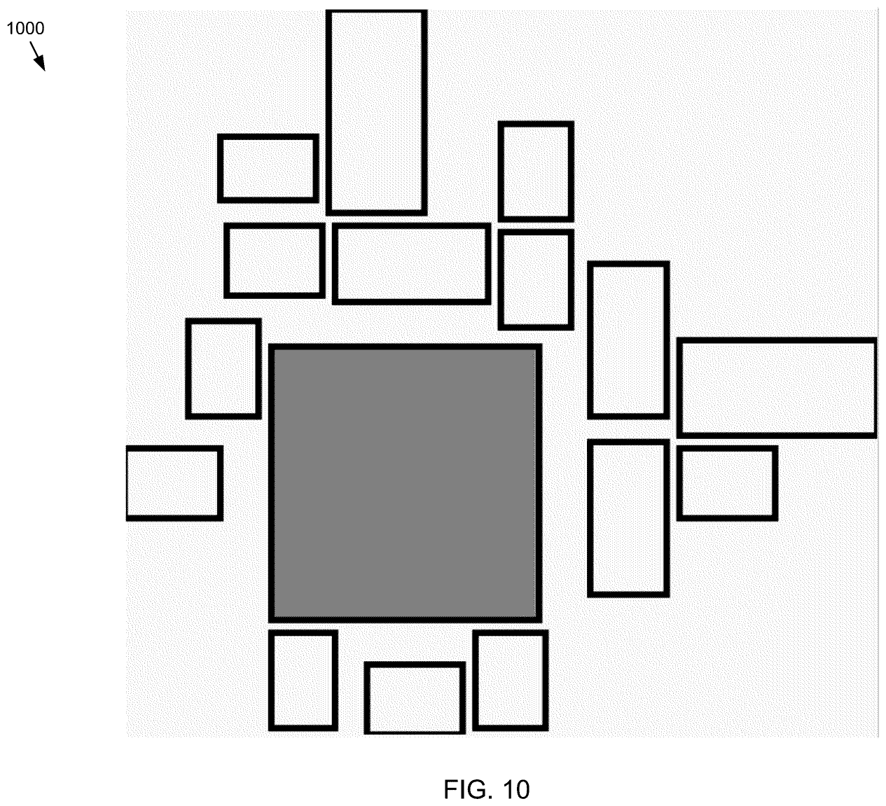

Referring now to FIGS. 7-10, example diagrams 700, 800, 900, 1000 showing examples of grid-based local placement consistent with embodiments of PCB component clustering process 10 are provided. These diagrams depict examples of the output of the detailed grid-based placement on four different groupings. The main placeable selected is shown by the gray component in each of these particular diagrams.

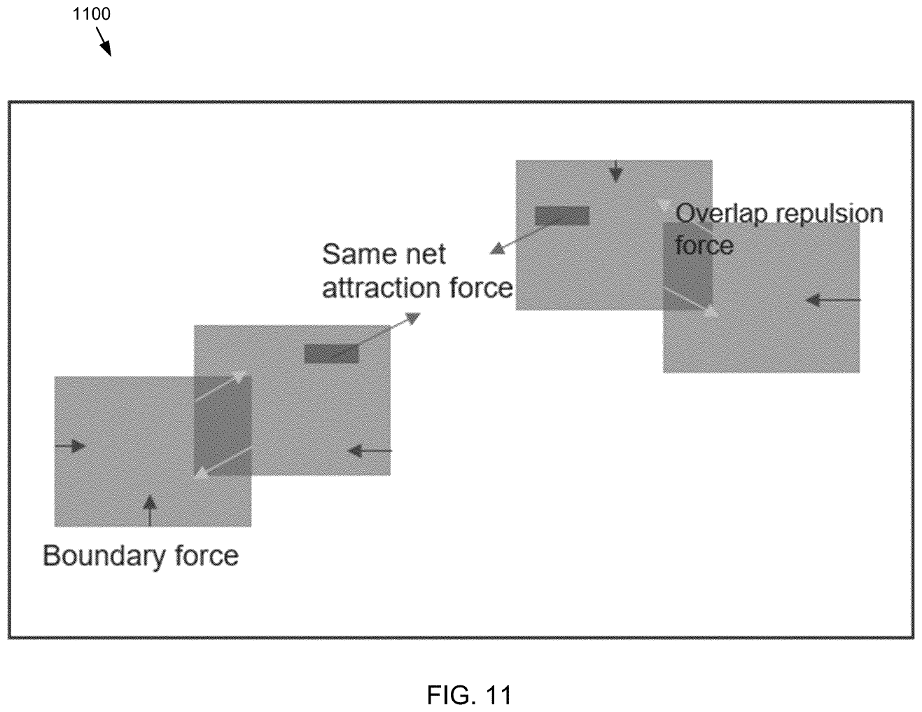

Referring now to FIG. 11, a diagram 1100 showing an example of gradient descent global placement consistent with embodiments of PCB component clustering process 10 is provided. PCB component clustering process 10 may utilize gradient descent global placement, which may be applied to clusters and components in their entirety. PCB component clustering process 10 may use global placement in a number of ways. For example, in cluster placement where one or more clusters may be moved around as a single unit to minimize wirelength and overlaps. Global placement may also be used in final legalization where the process may move individual components around just enough to minimize overlaps. Global placement is a conjugate-gradient descent optimization. The fitness function is a linear combination of a smooth wirelength function and an overlap penalty. The output is a position optimized arrangement of components or clusters. The same net attraction force may be calculated through the derivative of a continuous form of half perimeter wire length “hpwl” (e.g., position:velocity::hpwl:derivative of hpwl). Similarly, overlap repulsive force and boundary force may be calculated in the same way with a formulation of overlap area and then taking the derivative. These are discussed in further detail hereinbelow.

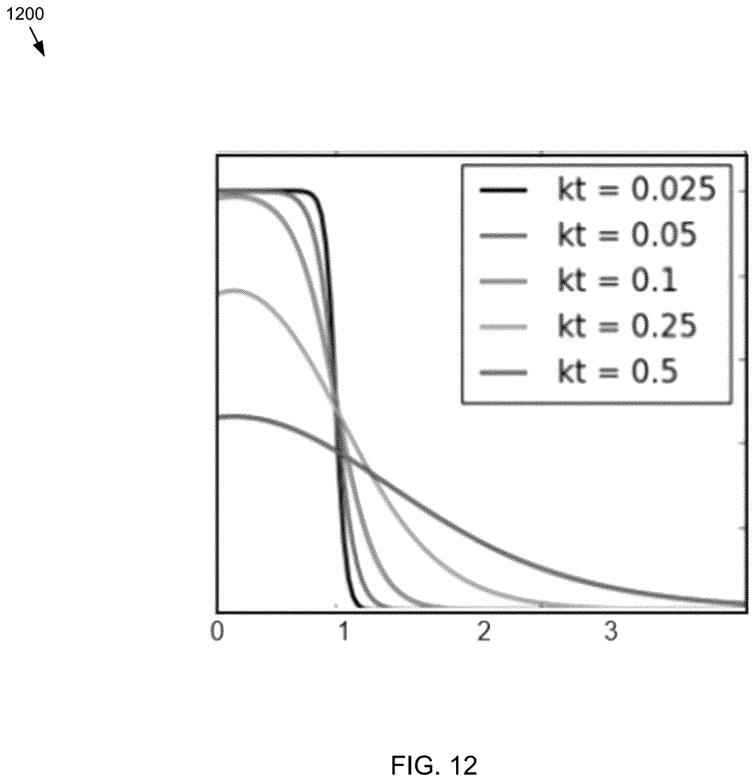

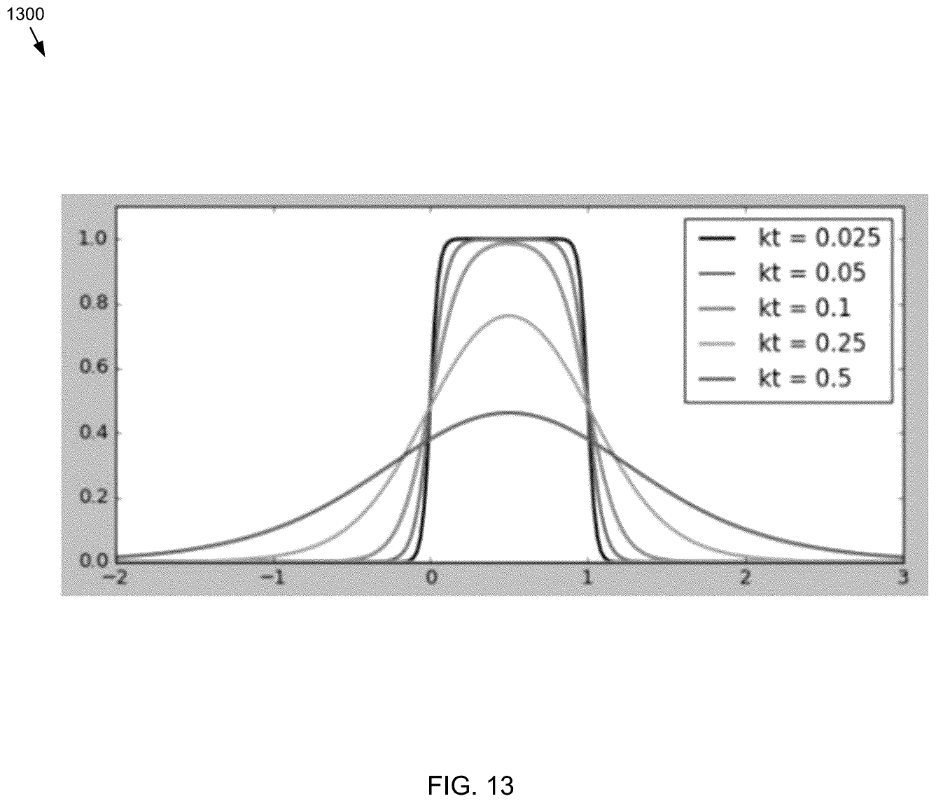

Referring now to FIGS. 12-15, various diagrams showing examples of block illustrations and equations including sample plots, showing the calculations of repulsive and attractive forces. FIGS. 12 and 13 show an example depicting a repulsive force computation including shape function and overlap integral.

We start with a Fermi-Dirac distribution function:

$$g ( x ) = \frac{1}{1 + {e}^{\frac{x - a}{kT}}} \qquad ( EQUATION 1 )$$

The plot in FIG. 12 shows the slopes for various values of kT and a=1. We use this function to represent two edges of a block, a and b and create a shape function:

$$s ( x ) = \frac{1}{1 + {e}^{\frac{a - x}{kT}}} + \frac{1}{1 + {e}^{\frac{x - b}{kT}}} - 1 \qquad ( EQUATION 2 )$$

The plot in FIG. 13 shows the slopes of the shape function for various values of kT and a=0 and b=1.

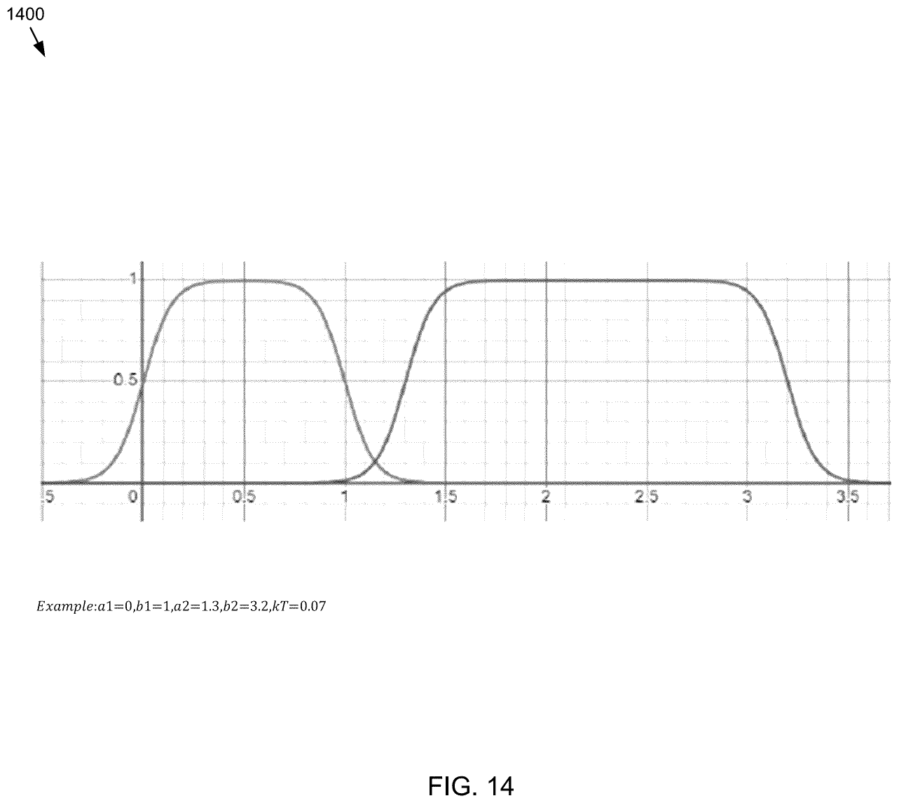

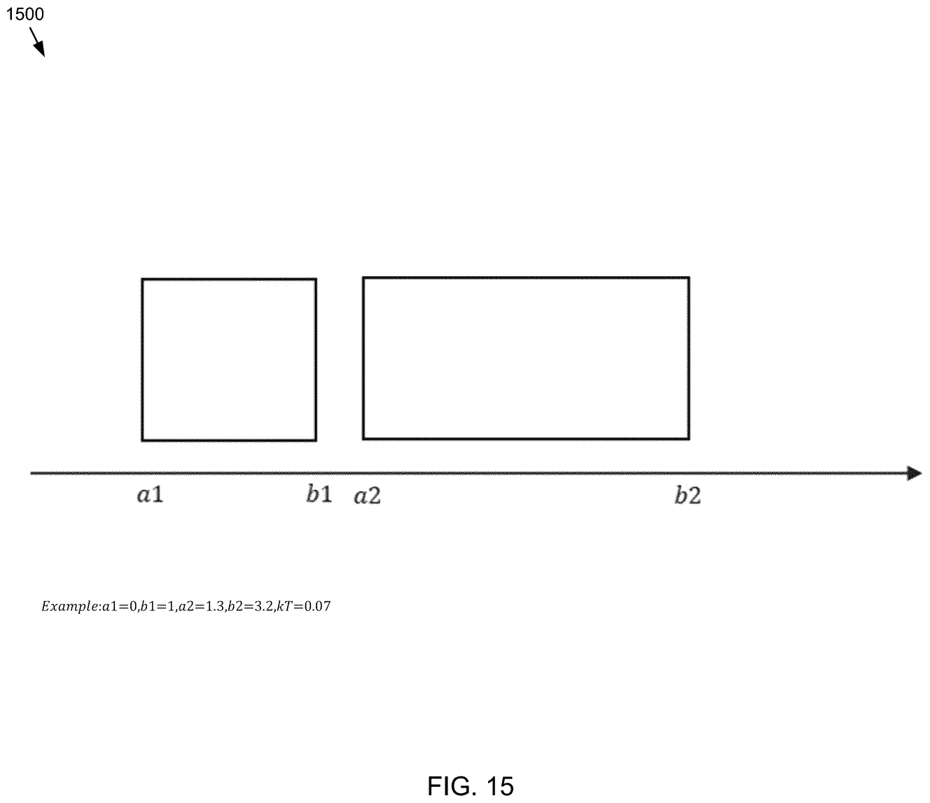

FIGS. 14 and 15 show an example depicting an overlap between two blocks. In this example, we have a with left and right x coordinates at a1 and b1, and a block with left and right x at a2 and b2. Shape functions are drawn on the top of the illustration shown in FIG. 14. For two blocks we define two shape functions as:

$$\begin{matrix}{s}_{1} ( x ) = \frac{1}{1 + {e}^{\frac{a 1 - x}{kT}}} + \frac{1}{1 + {e}^{\frac{x - b 1}{kT}}} - 1 , & {s}_{2} ( x ) = \frac{1}{1 + {e}^{\frac{a 2 - x}{kT}}} + \frac{1}{1 + {e}^{\frac{x - b 2}{kT}}} - 1\end{matrix} \qquad ( EQUATION 3 )$$

Their overlap is quantified as integral:

$${I}_{12} = {\int }_{- ∞}^{∞} {s}_{1} ( x ) \cdot {s}_{2} ( x ) dx \qquad ( EQUATION 4 )$$

And lastly the force between the is derivative of the overlap:

$$F = \frac{{dI}_{12}}{da} \qquad ( EQUATION 5 )$$

An example showing an attractive force computation is provided below. In this example, let E be a set of all nets, v set of pins on a net and γ a controllable parameter.

Half perimeter wirelength is define as:

$${\sum }_{e ∈ E} ( {max}_{v , {v}_{j}}^{pins} \vert {x}_{i} - {x}_{j} \vert + {max}_{v , {v}_{j}}^{pins} \vert {y}_{i} - {y}_{j} \vert ) \qquad ( EQUATION 6 )$$

We minimize this by assigning the attractive force in the amount:

$$W ( x , y ) = γ {\sum }_{e ∈ E} ( log {\sum }_{{v}_{k} ∈ e} {e}^{\frac{{x}_{k} - {x}_{max}}{γ}} + log {\sum }_{{v}_{k} ∈ e} {e}^{- \frac{{x}_{k} + {x}_{max}}{γ}} + log {\sum }_{{v}_{k} ∈ e} {e}^{\frac{{y}_{k} - {y}_{max}}{γ}} + log {\sum }_{{v}_{k} ∈ e} {e}^{- \frac{{y}_{k} - {y}_{max}}{γ}} ) \qquad ( EQUATION 7 )$$

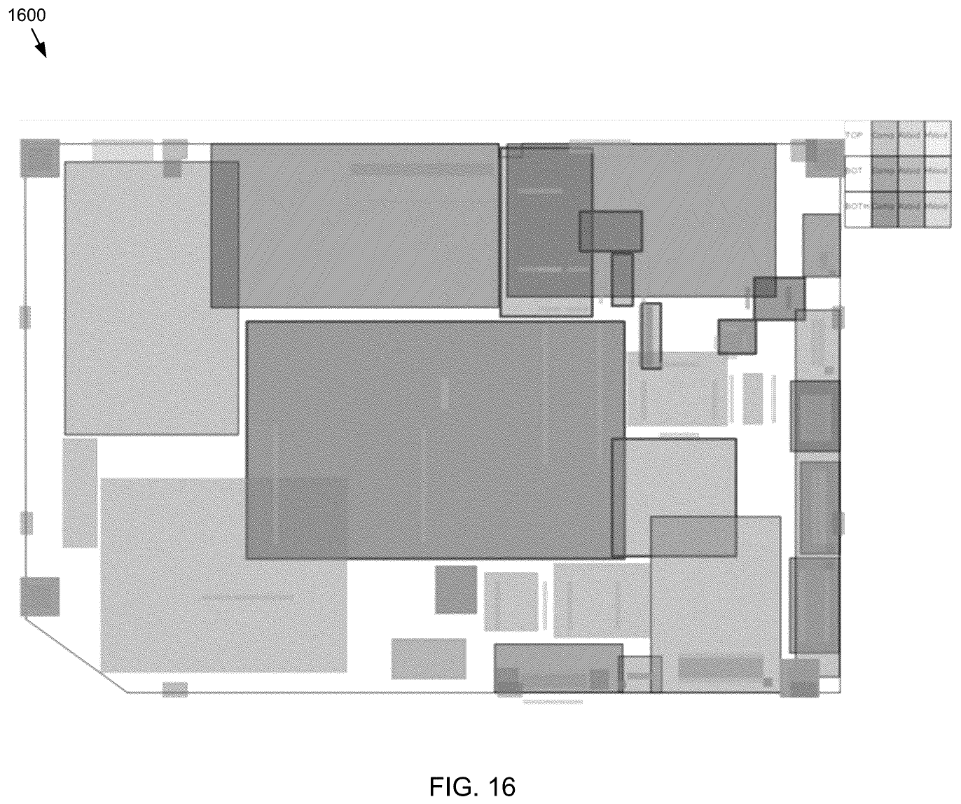

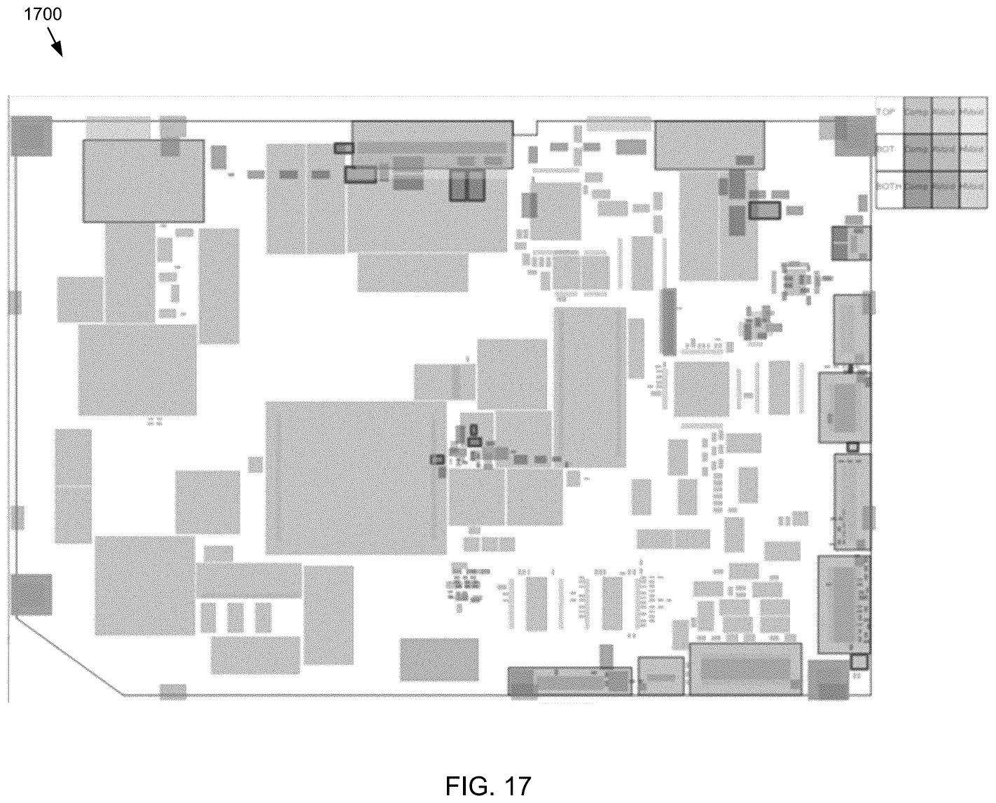

FIG. 16 shows an example diagram of global placement results with cluster bounds depicted and FIG. 17 shows an example diagram with individual components depicted. In these examples the cluster bounds may refer to the bounding box drawn around the bounds of each individual component in that cluster. The component bounds may refer to the shape of the component.

In some embodiments, and as discussed above with referent to FIG. 3, PCB component clustering process 10 may utilize feedback mechanisms to improve performance. These may include both internal and external feedback. With internal feedback every placement step may send the design back to a previous step. For example, after global cluster placement, the results could be sent back to clustering to reconstruct clusters. As an example, in some cases after global placement we will end up with overlapping clusters. When this occurs, PCB component clustering process 10 may feedback the output of global placement to local placement with new placement bounds to ensure no overlaps. With regard to external feedback the placement legalization operation may be responsible for calling external tools to analyze the result of the placement and may then dispatch a previous step to modify the placement given the analysis. Some examples of external analysis may include, but are not limited to, IR drop tools, signal integrity tools, and off-the-shelf routers or neural networks for routability evaluation. The results from such an external analysis may be used to identify trouble spots such as routing congestion areas or suboptimal signal path, which may be fedback to the placement flow to eliminate these issues.

Embodiments of PCB component clustering process 10 provides numerous advantages over existing approaches. Embodiments included herein are fully automated needing minimum human intervention and are far faster compared to human PCB placement, normally running in a few hours for mid-complexity designs (with hundreds of components) which would normally take weeks for a human designer. Even if the final placement may need further refinement by the user, PCB component clustering process 10 generates an acceptable starting placement and may allow PCB designers to explore different constraint sets and layout configurations at the same time.

It should be noted that although certain embodiments included herein may reference machine learning or genetic algorithms, any analysis process may be used in accordance with the teachings of the present disclosure. For example, any evolutionary algorithm, genetic algorithm, genetic program, grouping genetic algorithm, evolutionary computing approach, metaheuristics, stochastic optimization, optimization approach, artificial intelligence technique, etc. may be used (e.g. in the analyzing and updating described herein) without departing from the teachings of the present disclosure.

It will be apparent to those skilled in the art that various modifications and variations can be made in the embodiments of the present disclosure without departing from the spirit or scope of the present disclosure. Thus, it is intended that embodiments of the present disclosure cover the modifications and variations provided they come within the scope of the appended claims and their equivalents.

What is claimed is:

1. A computer-implemented automated printed circuit board (PCB) component placement method comprising:
receiving a PCB outline and a netlist having PCB component details;
applying a clustering algorithm to generate one or more clustered groups;
applying a grid based local cluster placement algorithm to the one or more clustered groups;
applying a global cluster placement algorithm; and
generating a fully optimized placed design.

2. The computer-implemented method of claim 1, further comprising:
providing a first current placement from a clustering algorithm as feedback to the clustering algorithm.

3. The computer-implemented method of claim 1, further comprising:
providing a second current placement from a global cluster placement algorithm as feedback to the global cluster placement algorithm.

4. The computer-implemented method of claim 1, further comprising:
providing a third current placement from a grid based local cluster placement algorithm as feedback to the grid based local cluster placement algorithm.

5. The computer-implemented method of claim 1, wherein the global cluster placement algorithm includes conjugate gradient descent optimization.

6. The computer-implemented method of claim 1, further comprising:
providing feedback to optimize placement for wire length and routability.

7. The computer-implemented method of claim 1, wherein the clustering algorithm includes spectral clustering approaches.

8. The computer-implemented method of claim 1, wherein the grid based local cluster placement algorithm includes identifying a component having a largest number of pins.

9. The computer-implemented method of claim 5, further comprising:
generating a visualization at a graphical user interface including global placement results.

10. The computer-implemented method of claim 1, wherein the fully optimized placed design is placed and routed on a same layer.

11. A computer-readable medium having stored thereon instructions that when executed by a processor result in one or more operations, the operations comprising:
receiving a PCB outline and a netlist having PCB component details;
applying a clustering algorithm to generate one or more clustered groups;
applying a grid based local cluster placement algorithm to the one or more clustered groups;
applying a global cluster placement algorithm; and
generating a fully optimized placed design.

12. The computer-readable medium of claim 11, further comprising:
providing a first current placement from a clustering algorithm as feedback to the clustering algorithm.

13. The computer-readable medium of claim 11, further comprising:
providing a second current placement from a global cluster placement algorithm as feedback to the global cluster placement algorithm.

14. The computer-readable medium of claim 11, further comprising:
providing a third current placement from a grid based local cluster placement algorithm as feedback to the grid based local cluster placement algorithm.

15. The computer-readable medium of claim 11, wherein the global cluster placement algorithm includes conjugate gradient descent optimization.

16. The computer-readable medium of claim 11, further comprising:
providing feedback to optimize placement for wire length and routability.

17. The computer-readable medium of claim 11, wherein the clustering algorithm includes spectral clustering approaches.

18. The computer-readable medium of claim 11, wherein the grid based local cluster placement algorithm includes identifying a component having a largest number of pins.

19. The computer-readable medium of claim 15, further comprising:
generating a visualization at a graphical user interface including global placement results.

20. The computer-readable medium of claim 11, wherein the fully optimized placed design is placed and routed on a same layer.
